(19) United States
(12) Patent Application Publication
(10) Pub. No.: US 2008/0175608 A1
(43) Pub. Date: Jul. 24, 2008

(54) IMAGE FORMING APPARATUS AND METHOD THEREOF

(75) Inventor: Kei Kobashigawa, Odawara-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/626,496

(22) Filed: Jan. 24, 2007

(51) Int. Cl. G03G 15/00; G03G 15/02; G03G 15/043; G03G 15/06

(52) U.S. Cl. 399/44; 399/49; 399/50; 399/51; 399/55

(57) ABSTRACT

According to an aspect of the invention, an image forming apparatus having a plurality of processing velocities is characterized by a control for determining the image forming process conditions by redefining a first approximate expression for estimating the unexposed surface potential value Vo of a photoconductive drum as a continuous function of the charging potential Vd according to the change of the natural environmental temperature, the change of the surface temperature of the photoconductive drum, the change of the photoconductive drum due to fatigue, or the exposure value, and a second approximate expression for estimating the exposed surface potential value VL of the photoconductive drum as a continuous function of the charging potential Vd according to the change of the processing velocity, using the first approximate expression and the second approximate expression to determine the optimal values of the developing potential, the background potential, and the exposure value for the respective processing velocities, and determining the image forming process conditions and computing the charging potential Vd, and the developing bias Vb to be realized as the image forming process on the photoconductive drum, and an image forming apparatus therefore.

### 1. FIELD OF THE INVENTION

The present invention relates to an image forming apparatus that is capable of controlling and correcting image forming conditions in an image forming process when the surface potential of an image carrier member is varied due to various reasons and a method thereof.

### 2. DESCRIPTION OF THE BACKGROUND

In general, in an image forming apparatus employing an electrophotographic system, image forming conditions in the image forming process such as the charging potential of a charging device, the developing bias to be applied to a developing roller, or the exposure value of an exposure device are adjusted in order to maintain the density of toner and fogging in an formed image at a predetermined value. With such adjustment, the developing potential, the background potential and the like that are maintained by a photoconductor at the time of development are controlled. In particular, in the case of a color image forming apparatus which obtains a color image by superimposing toner images in a plurality of colors, since the developing characteristic of developer varies by color, it is necessary to adjust the image forming conditions in the image forming process for each color to obtain adequate toner densities and tones of the formed image in all the colors.

In general, the surface potential and the charging potential of the photoconductor in the image forming apparatus have a relation shown in FIG. 1 (provided that the exposure value in FIG. 1 is constant). As is clear from FIG. 1, the sum of the developing potential and the background potential at the time of development corresponds to a difference between the surface potential of the photoconductor before exposure (unexposed surface potential value Vo) and the surface potential after exposure (exposed surface potential value VL). Therefore, the desired developing potential and the background potential can be obtained by controlling the charging potential of the charging device, the exposure value of the exposure device and the like and adjusting the developing bias to make the surface potential of the photoconductor a desired value.

However, the surface potential of the photoconductor may vary also by a change of natural environment such as the temperature, the moisture in the vicinity of the photoconductor, deterioration of the photoconductor characteristics due to, for example, fatigue of the photoconductor irrespective of control of the charging potential of the charging device or the exposure value of the exposure device. Therefore, in order to obtain the desired developing potential and the background potential, it is necessary to control the charging potential of the charging device, the exposure value of the exposure device or the like to make the developing potential and the background potential of the photoconductor the desired values, while sensing the surface potential on the photoconductor as needed using a sensor.

For example, JP-A-7-261480 discloses an image forming apparatus which obtains a contrast potential and a background potential by detecting a characteristic change of a photoconductor from the surface potential and correcting the grid bias value of a charging device and the developing DC bias value of a developing device. That is, this document discloses a technology to detect the surface potential of the photoconductor by a potentiometer and obtaining values of the charging potential (grid bias) and the developing bias that can reproduce the developing contrast potential (potential) and the background potential to be formed on the basis of the surface potential. It also discloses a technology to detect the surface potential of the photoconductor during the execution of the process to correct the charging potential (grid bias) and the developing bias also when forming images consecutively.

However, in general an expensive measuring device is necessary for measuring the surface potential of the image forming apparatus in the related art. In the case of a color image forming apparatus having a plurality of photoconductors (image carrier members) for example, a plurality of the expensive measuring devices for each photoconductor have to be provided, which is disadvantageous in terms of cost.

There already exists a method of keeping the unexposed surface potential value Vo on the photoconductor always constant by estimating the variation of unexposed potential from natural environment, such as the peripheral temperature of the image forming apparatus and correcting the charging potential, and setting the developing potential and the background potential by changing the developing bias by controlling the dark portion surface potential by the exposure value so that the difference between the unexposed surface potential value Vo and the exposed surface potential value VL is kept always constant. In the case of this method, the sensor for measuring the surface potential and the device therefor are not necessary.

However, since the difference between the unexposed surface potential value Vo and the exposed surface potential value VL is already fixed, the value which can be obtained by adjusting the developing bias is either the developing potential or the background potential. Therefore, the required values of the developing potential and the background potential cannot necessarily be obtained simultaneously.

Therefore, there is a method to further adjust the exposure value and additionally adjust the exposed surface potential value VL in order to obtain both of the required values of the developing potential and the background potential. When adjustment of the exposure value is performed, the difference between the unexposed surface potential value Vo and the exposed surface potential value VL also varies due to the variation of the exposed surface potential value VL. Therefore, if the background potential is not changed, the developing potential increases or decreases. Consequently, the image density can be adjusted, but adjustment of the exposure value affects the intermediate tone density of the image. That is, the intermediate tone density which has been determined by the background potential before the exposure value is adjusted varies, so that the desired image quality may not be obtained.

That is, in the multi-color image forming apparatus, even though adjustment of the developing potential or the background potential is desired for achieving adequate density and tone reproducibility for each color, it is difficult to reproduce the content of adjustment of the developing potential or the background potential on the photoconductor in the image forming apparatus through the setting of the charging potential, the developing bias, and the exposure value. Even though the content of adjustment of the potential or the background potential can be reproduced on the photoconductor, the charging bias potential, the developing bias, and the exposure value are required to be set again every time (1) when the unexposed surface potential value Vo and the exposed surface potential value VL on the surface of the photoconductor are varied by a change of natural environment where the image forming apparatus is placed, and (2) when there arises a necessity to perform an adequate adjustment of the developing potential, the background potential, or the exposure value again because of the change of the developing process or the state of developer during image formation.

In order to do so, it is necessary to measure the surface potential of the image carrier member with an expensive surface potential measuring device to know the state of the surface potential, and reset these values. Alternatively, it is necessary to omit the measurement of the surface potential by estimating the variation of the surface potential of the image carrier member, adjust the exposing bias that can provide the developing potential and the background potential while securing at least a certain difference between the unexposed surface potential value Vo and the exposed surface potential value VL, and adjust the density of each color by adjusting the exposure value at the risk of fluctuation of the intermediate tone density. At any rate, there eventually remain problems of cost and image reproducibility.

On the other hand, there is a demand for a multi-function and high-performance image forming apparatus in which toner fixing property is improved by using a plurality of processing velocities for obtaining functions such as forming a photographic image on photographic printing paper, and the image density, tone reproducibility, glossiness of color images, or color tone are improved. However, when the variable processing velocity is employed, the optimal values of the developing potential and the background potential may vary depending on the processing velocity. Therefore, it is necessary to know how to obtain the optimal values, and to set the image forming conditions for the image forming process for reproducing the developing potential and the background potential desired as the optimal value on the photoconductor.

Therefore, there is a demand for an image forming apparatus which can determine the developing potential, the background potential, or the exposure value which are optimal for each of a plurality of processing velocities, and can set the charging potential and the developing bias for reproducing the same easily.

### SUMMARY OF THE INVENTION

It is an aspect of the present invention to provide a high-performance image forming apparatus having a plurality of processing velocities, which is capable of forming high-quality toner images at respective processing velocities by adjusting image forming conditions for an image forming process easily at a low cost even in a circumstance in which the charging characteristic of an image carrier member varies.

According to an embodiment of the invention, the image forming apparatus includes an image carrier member; an image forming unit having a charging unit that charges the image carrier member evenly and controls the amount of electric charge by a charging potential to be applied, an exposure unit that forms a latent image on the image carrier member, and a developing unit that applies a developing bias, supplies toner to the latent image on the image carrier member, and develops the same, the image forming unit performing an image forming process on the image carrier member for forming a toner image; and a velocity switching unit that switches the processing velocity in the image forming unit in a plurality of levels, wherein in a plurality of the processing velocities in the image forming unit, the unexposed surface potential value of the image carrier member is estimated using a first approximate expression as a continuous function of the charging potential of the charging unit and the exposed surface potential value of the image carrier member is estimated using a second approximate expression as a continuous function of the charging potential of the charging unit for each processing velocity, and the developing potential required for the respective processing velocity, the charging potential to be applied to the image carrier member for realizing a background potential on the image carrier member, the developing bias of the developing unit and the exposure value of the exposure unit can be computed and, in the first and second approximate expressions for estimating the surface potential value of the image carrier member, one or more of the peripheral environment in the vicinity of the image carrier member, the fatigue, and the exposure value at the time of the latent image formation are selected to define the continuous function, and the charging potential to be applied to the image carrier member, the developing bias of the developing unit, and the exposure value of the exposure unit are computed for each processing velocity.

In order to optimize the developing potential, the background potential, and the exposure value at the plurality of processing velocities of the image forming unit, the invention is characterized by the provision of a control unit including a member that performs the image forming process using control and computation of the image forming unit, forms a test pattern as a toner image, and measures the density of the test pattern as an amount of attached toner, and a pattern density determining means that compares the measured value of the amount of attached toner with a preset target value to determine whether the density of the test pattern is acceptable or not and, when it is not acceptable, the control unit calculates optimal values of the developing potentials, the background potentials, and the exposure values for the plurality of process velocities that the image forming process has by a member for changing the developing potential and the exposure value (or the background potential) of the image forming process for optimizing the pattern density.

Alternatively, the invention is characterized by the provision of the control unit including a member that performs the image forming process using control and computation of the image forming unit for optimizing the optimal values of the developing potential, the background potential, and the exposure value at a specific processing velocity of the image forming unit, forms a test pattern as a toner image, and measures the density of the test pattern as the amount of attached toner, and a pattern density determination unit that compares the measured value of the amount of attached toner with a preset target value and determines whether the density of the test pattern is acceptable or not, and, when it is not acceptable, the control unit calculates the optimal values of the developing potential and the exposing value for a first processing velocity that the image forming process has by a member that changes the developing potential and the exposure value (or the background potential) of the image forming process for optimizing the pattern density, and applies the result obtained by correcting the value of the developing potential and the exposure value (or the background potential) for the first processing velocity at processing velocities other than the first processing velocity.

### BRIEF DESCRIPTION OF THE DRAWINGS

FIG. 1 is a graph showing a general relationship between the surface potential and the charging potential of an image carrier member of an image forming apparatus;

FIG. 2A illustrates a schematic configuration of a color printer apparatus according to an embodiment of the invention;

FIG. 2B illustrates a schematic configuration of an image forming station according to the embodiment of the invention;

FIG. 3 is a block diagram showing a control system of a printer according to the embodiment of the invention;

FIG. 4 is a graph of a linear function of a relation of the charging potential of a photoconductive drum with respect to the unexposed surface potential value and the exposed surface potential value according to the embodiment of the invention;

FIG. 5 shows Table 1 including values of a1, b2, b1, and b2 for respective measured temperatures of a drum thermistor according to the embodiment of the invention;

FIG. 6 shows Table 2 including adequate developing potentials Vc and adequate background potentials Vbg for the respective peripheral temperatures of the photoconductive drum according to Example 1 of the embodiment of the invention;

FIG. 7 is a flowchart showing calculation of the charging potentials and developing biases in accordance with the natural environment temperatures according to the embodiment of the invention;

FIG. 8 shows Table 3 including the values of a1, a2, b1, and b2 for the respective drive times of the photoconductive drum according to Example 1 of the embodiment of the invention;

FIG. 9 is a flowchart showing calculation of the charging potentials and the developing biases according to the fatigue of the photoconductive drum according to Example 1 of the embodiment of the invention;

FIG. 10 shows Table 4 including the values of a1, a2, b1, and b2 for the respective exposure values according to Example 1 of the embodiment of the invention;

FIG. 11 is a flowchart showing calculation of the charging potentials and the developing biases according to the change of the exposure value according to Example 1 of the embodiment of the invention;

FIG. 12 is a flowchart showing an image forming process according to Example 2 of an embodiment of the invention;

FIG. 13 is a flowchart showing an image forming process according to Example 3 of an embodiment of the invention;

FIG. 14 shows Table 5 including the developing potentials Vc, the background potentials Vbg, and the exposure values L at a first processing velocity which is a reference velocity in Example 3 of the embodiment of the invention;

FIG. 15 shows Table 6 including the developing potentials Vc, the background potentials Vbg, and the exposure values L at a second processing velocity for inspecting the amount of correction according to Example 3 of the embodiment of the invention; and

FIG. 16 shows Table 7 including the amounts of correction for the optimal values of the developing potentials Vc, the background potentials Vbg, and the exposure values L at the first processing velocity and the second processing velocity applied to Example 3 of the embodiment of the invention.

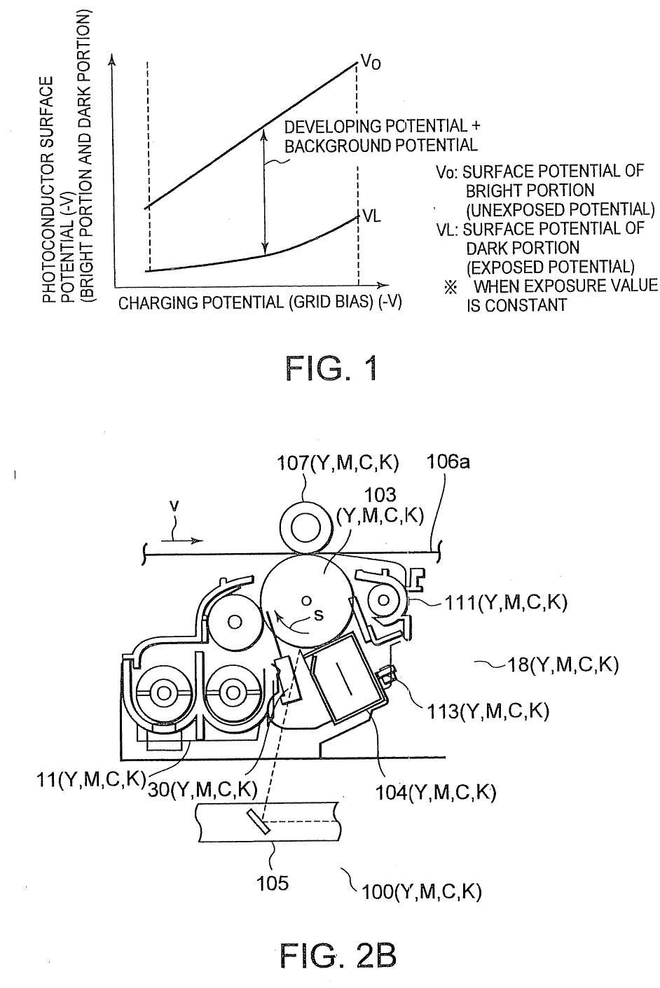

### DETAILED DESCRIPTION OF THE INVENTION

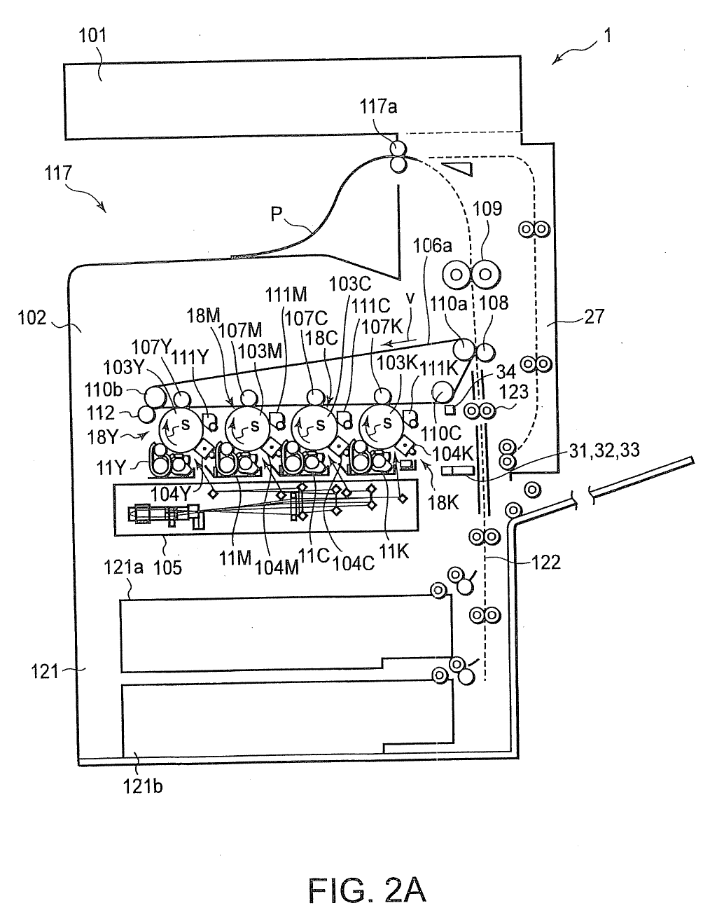

Referring now to the attached drawings as examples, a first embodiment of the invention will be described in detail. FIG. 2A illustrates a schematic configuration of a color printer apparatus 1 as an image forming apparatus according to the embodiment of the invention. The color printer apparatus 1 includes a paper feed device 121 for feeding sheet papers P toward a printer 102 therein. The paper feed device 121 takes out the sheet papers P from paper feed cassettes 121a, 121b and feed the sheet papers P toward resist rollers 123 along a carrier path 122. A scanner 101 for reading images of original documents is provided on the upper surface of the color printer apparatus 1.

The printer 102 performs image formation using an electrophotographic system which employs reverse development. The printer 102 includes four sets of image forming stations 18Y, 18M, 18C and 18K for yellow (Y), magenta (M), cyan (C), and black (K) which are arranged in parallel along the lower side of an intermediate transfer belt 106a. The image forming stations 18Y, 18M, 18C and 18K have the same configuration.

FIG. 2B illustrates a schematic configuration of the image forming stations 18Y, 18M, 18C, and 18K. The respective image forming stations 18Y, 18M, 18C, and 18K include photoconductive drums 103Y, 103M, 103C, and 103K, respectively. Chargers 104Y, 104M, 104C, and 104K as charging units, developing devices 11Y, 11M, 11C, and 11K as developing units, photoconductor cleaners 111Y, 111M, 111C, and 111K, and diselectrifiers 113Y, 113M, 113C, and 113K are arranged around the photoconductive drums 103Y, 103M, 103C, and 103K respectively along the direction of rotation indicated by an arrow s.

A section around the photoconductive drums 103Y, 103M, 103C, and 103K from the chargers 104Y, 104M, 104C, and 104K to the developing devices 11Y, 11M, 11C, and 11K, is irradiated with exposure light by a laser exposure device 105. The chargers 104Y, 104M, 104C, and 104K, the laser exposure device 105, and the developing devices 11Y, 11M, 11C, and 11K constitute image forming sections 101Y, 100M, 100C, and 100K for forming toner images on the photoconductive drums 103Y, 103M, 103C, and 103K.

Drum thermistors 30Y, 30M, 30C, and 30K as environment detecting units are in contact with a non-image forming area of the photoconductive drums 103Y, 103M, 103C, and 103K. The drum thermistors 30Y, 30M, 30C, and 30K sense the surface temperatures of the photoconductive drums 103Y, 103M, 103C, and 103K. The photoconductive drums 103Y, 103M, 103C, and 103K may constitute process units by being supported integrally with, for example, the chargers 104Y, 104M, 104C, and 104K by unit frames.

The intermediate transfer belt 106a is tightly extended around a drive roller 110a, a driven roller 110b, and a tension roller 110c. Reference numeral 112 designates a belt cleaner. Primary transfer rollers 107Y, 107M, 107C, and 107K are arranged at primary transfer positions where the intermediate transfer belt 106a opposes the photoconductive drums 103Y, 103M, 103C, and 103K with the intermediary of the intermediate transfer belt 106a.

Secondary transfer roller 108 is arranged at a secondary transfer position where the intermediate transfer belt 106a is supported by the drive roller 110a so as to oppose thereto. The sheet papers P are supplied to the second transfer position, for example, from the paper feed cassette 121a or 121b. The secondary transfer roller 108 secondarily transfers a color toner image including the toner images in a plurality of colors superimposed one on top of another on the transfer belt 106a to the sheet paper P. A pattern density sensor 34 as a measuring unit for sensing the density of toner images formed on the transfer belt 106a is provided in the vicinity of the transfer belt 106a before reaching the drive roller 110a.

The printer 102 further includes a fixer 109 for fixing the color toner image on the sheet paper P, which is transferred by the secondary transfer roller 108, and a paper discharge roller 117a for discharging the sheet paper P after fixation to a paper discharge unit 117. The printer 102 also includes a reverse carrier device 27 for reversely feeding the sheet paper P for both-side printing. The printer 102 further includes a temperature sensor 31, an atmospheric pressure sensor 32, and a relative moisture sensor 33 as environment sensing units for determining the natural environment arranged therein. The temperature sensor 31, the atmospheric pressure sensor 32, and the relative moisture sensor 33 are arranged at adequate positions where outer air can be introduced into the printer 102 and the peripheral temperatures around the image forming stations 18Y, 18M, 18C, and 18K can be measured.

The color printer apparatus 1 reads an original document via the scanner 101 when the image forming process is started. In the printer 102, the respective image forming stations 18Y, 18M, 18C, and 18K are driven and the transfer belt 106a is rotated in the direction indicated by an arrow v. The photoconductive drums 103Y, 103M, 103C, and 103K are electrically charged by the chargers 104Y, 104M, 104C, and 104K in accordance with the rotation in the direction indicated by an arrow s, are formed with electrostatic latent images according to the original document by the laser exposure device 105, and are formed with the toner images by the developing devices 11Y, 11M, 11C, and 11K.

The toner images on the photoconductive drums 103Y, 103M, 103C, and 103K are superimposed in sequence on the intermediate transfer belt 106a by the primary transfer rollers 107Y, 107M, 107C, and 107K for applying a primary transfer voltage, so that a color toner image is formed on the transfer belt 106a. The color toner image formed on the transfer belt 106a reaches the secondary transfer position, and is secondarily transferred to the sheet paper P at once by a transfer bias of the secondary transfer roller 108.

The sheet papers P are carried to the secondary transfer position from the paper feed device 121 synchronously with the moment when the color toner image on the transfer belt 106a reaches the secondary transfer position. Then, the color toner image is fixed on the sheet paper P by the fixer 109, and hence the sheet paper is formed with a complete color image thereon, and is accumulated in the paper discharge unit 117. On the other hand, after having transferred to the sheet paper P, residual toner is cleaned off from the transfer belt 106a by the belt cleaner 112. After the primary transfer, residual toner is removed from the photoconductive drums 103Y, 103M, 103C, and 103K by the photoconductor cleaners 111Y, 111M, 111C, and 111K, and residual electric charge is removed therefrom by the diselectrifiers 113Y, 113M, 113C, and 113K.

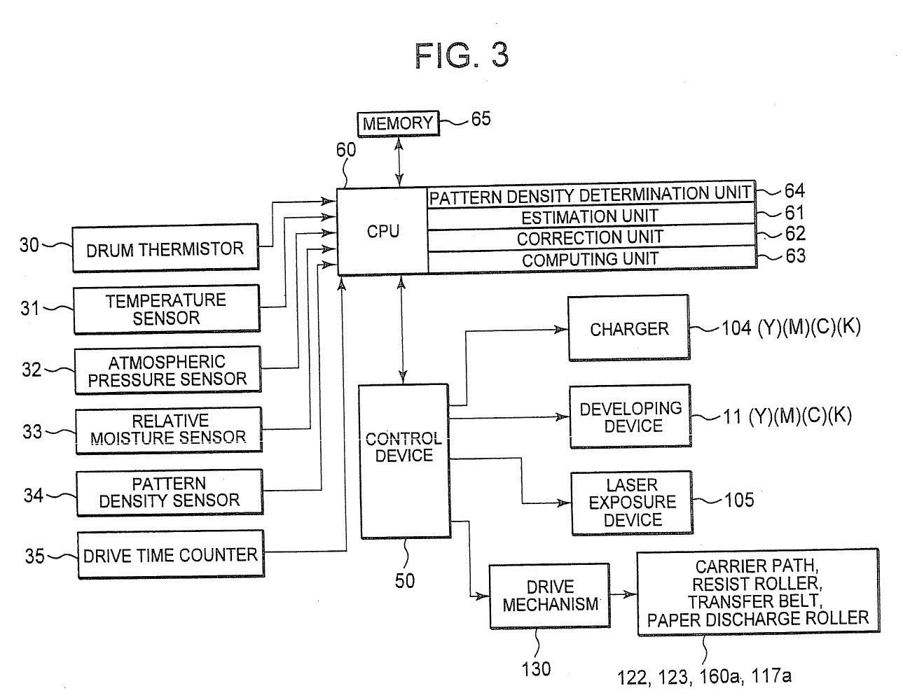

Then, adjustment of the image forming conditions of an image forming section 100 when performing the toner image forming process will be described. FIG. 3 shows a block diagram of a control system of the printer 102. A control device 50 as a controller controls charging potentials Vd of the respective chargers 104Y, 104M, 104C, and 104K and the developing biases Vb of the respective developing devices 11Y, 11M, 11C, and 11K for yellow (Y), magenta (M), cyan (C), and black (K) according to the image forming conditions. The control device 50 controls exposure values L for yellow (Y), magenta (M), cyan (C), and black (K) respectively of the laser exposure device 105.

The control device 50 is connected to a CPU 60 for controlling the entire color printer apparatus 1. Sensed results from the drum thermistor 30, the temperature sensor 31, the atmospheric pressure sensor 32, the relative moisture sensor 33, the pattern density sensor 34 or a drive time counter 35, described later, for the photoconductive drums 103Y, 103M, 103C, and 103K are entered to an input side of the CPU 60.

The CPU 60 includes a estimation unit 61 for estimating the unexposed surface potential value Vo, which is the surface potential before exposure and the exposed surface potential value VL, which is the surface potential after exposure when the photoconductive drums 103Y, 103M, 103C, and 103K are charged to an arbitrary charging potential Vd by an approximate expression of a continuous function of the charging potential Vd.

The CPU 60 also includes a correction unit 62, which is a first computing unit for correcting the approximate expression used in the estimation unit 61 according to the sensed result from the drum thermistor 30, the temperature sensor 31, or the pattern density sensor 34. The correction unit 62 corrects the approximate expression used in the estimation unit 61 according to the drive time or the drive distance of the photoconductive drums 103, which correspond to the index of fatigue of the photoconductive drums 103. The correction unit 62 further corrects the approximate expression used in the estimation unit 61 according to fluctuation of the exposure value L of the laser exposure device 105 or fluctuation of the processing velocities of the image forming section 100.

The CPU 60 further includes a computing unit 63 as a second computing unit for calculating the charging potentials Vd of the respective chargers 104Y, 104M, 104C, and 104K and the developing biases Vb of the respective developing devices 11Y, 11M, 11C, and 11K using the approximate expression used in the estimation unit 61. The CPU 60 further includes a memory 65 and a pattern density determination unit 64. The pattern density determination unit 64 determines the density of test pattern formed on the transfer belt 106a, and determines whether the developing potential Vc, the background potential Vbg, and the exposure value L as the primary image forming conditions are to be adjusted or not. The pattern density determination unit 64 also serves as a controller for obtaining the error between the pattern density of a test pattern and a target density and calculating the optimal developing potential Vc, background potential Vbg, and exposure value L.

The respective chargers 104Y, 104M, 104C, and 104K, the respective developing devices 11Y, 11M, 11C, and 11K, and the laser exposure device 105 are connected to an output side of the control device 50. A drive mechanism 130 for driving the carrier path 122, the resist rollers 123, the transfer belt 106a, and the paper discharge roller 117a at predetermined processing velocities is also connected to the output side of the control device 50. The control device 50 variably controls the charging potentials Vd of the respective chargers 104Y, 104M, 104C, and 104K, the respective developing biases Vb of the respective developing devices 11Y, 11M, 11C, and 11K, or the exposure value L of the laser exposure device 105 according to the respective image forming conditions of the image forming section 100 supplied from the CPU 60.

Subsequently, a method of adjusting the image forming conditions will be described. Firstly, the approximate expression used in the estimation unit 61 of the CPU 60 will be described. Since the respective image forming stations 18Y, 18M, 18C, and 18K have the same configuration, indications of yellow (Y), magenta (M), cyan (C), and black (K) are omitted, and the common reference numeral will be used.

The estimation expression is created by obtaining measured results of the unexposed surface potential value Vo1 and the exposed surface potential value VL1 when charging potential is Vd1 and measured results of the unexposed surface potential value Vo2 and the exposed surface potential value VL2 when the charging potential is Vd2. It is because that it is necessary to measure the unexposed surface potential value Vo and the exposed surface potential value VL at the time when the photoconductive drum 103 is electrically charged by varying the charging potential Vd of the charger 104 in order to obtain the charging characteristic of the photoconductive drum 103 of the printer 102. The method of measuring the surface potential is not limited, and the timing of measurement may be immediately before adjustment of the image formation.

However, in this embodiment, the unexposed surface potential value Vo and the exposed surface potential value VL according to the various environmental conditions, the drive time of the photoconductive drum and the exposure value are measured in advance and stored in a memory 65 in the CPU 60 or the like. A method of reading the measured surface potential from the memory 65 according to the surface temperatures of the photoconductive drum 103, the peripheral temperatures, the atmospheric pressures, the relative moistures sensed by the respective sensors provided in the CPU 60, and the result of exposure value by the control device will be employed.

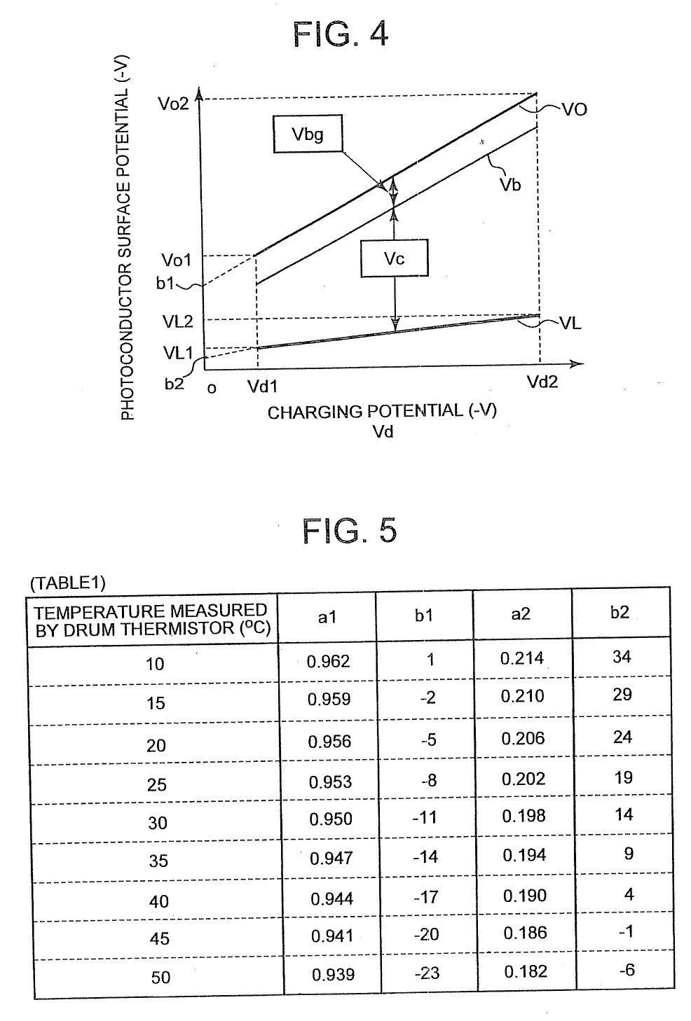

Accordingly, the relation between the charging potential (lateral axis; Vd) by the charger 104, and the surface potential of the photoconductive drum 103 (vertical axis; Vo) in the printer 102 employing the reverse development may be expressed in graph of a linear function as shown in FIG. 4.

The surface potential (irrespective of whether it is the unexposed surface potential value or the exposed surface potential value) is not necessarily proportional as shown in FIG. 4, and may be expressed in a curve of quadric or higher function when the charging potential is increasing. However, in this embodiment, it is expressed in the linear function as a matter of convenience. Although the color printer apparatus 1 in this embodiment has a plurality of processing velocities for forming images, adjustment of the image forming conditions in the image forming apparatus at a first processing velocity will be described first.

As described already, on the photoconductive drum 103, Vo−VL=developing potential (Vc)+background potential (Vbg). The developing bias Vb is set to satisfy expressions Vbg=Vo−Vb, Vc=Vb−VL.

According to FIG. 4, the unexposed surface potential value Vo expressed by the first approximate expression with the charging potential Vd as a function, and the exposed surface potential value VL expressed by the second approximate expression with the charging potential Vd as a function will be as follows;

Vo=a1×Vd+b1 first approximate expression

VL=a2×Vd+b2 second approximate expression

where, a1 represents the inclination of Vo, b1 represents the unexposed surface potential value when the value of Vd is 0, a2 represents the inclination of VL, b2 represents exposed surface potential when the value of Vd is 0, and a1≧a2.

Furthermore, FIG. 4 shows the developing biases Vb and the background potentials Vbg with the developing potential Vc for obtaining a desired image density. Since the sum of the developing potential Vc and the background potential Vbg corresponds to the difference between the unexposed surface potential value Vo and the exposed surface potential value VL of the photoconductive drum 103,

Vc+Vbg=Vo−VL=(a1−a2)×Vd+(b1−b2) Expression (3)

will be satisfied. Therefore, for example, when the developing potential Vc and the background potential Vbg required for obtaining the desired image density and preventing generation of base fogging are proved, the charging potential Vd to be set is obtained by developing the expression (3) and using the following expression.

Vd={(Vo−VL)−(b1−b2)}÷(a1−a2) Expression (4)

What is important when using the expression (4) is how to obtain the first approximate expression and the second approximate expression. The unexposed surface potential value Vo and the exposed surface potential value VL are both affected by variation in photoconductive characteristics due to the natural environment or deterioration of the photoconductive drum 103. Therefore, in this embodiment, (1) the measured results relating the unexposed surface potential value Vo and the exposed surface potential value VL according to the various environmental conditions, the drive time of the photoconductive drum, the exposure value or the like, which are measured in advance, are stored in the memory 65 of the CPU 60. (2) The measured surface potential is read from the memory 65 according to the surface temperature of the photoconductive drum 103 sensed by the various sensors provided in the CPU 60, the peripheral temperature, the atmospheric pressure, the relative moisture, the drive time of the photoconductive drum 103, the exposure value or the like. (3) The values of a1, a2, b1, and b2 are found every time, and computation to obtain the charging potential Vd is performed from the expression (4).

According to this embodiment, it is no longer necessary to measure the surface potential of the photoconductive drum by the potential measuring device in which the surface potential sensor is employed every time when the printing job is started irrespective of the variation in photoconductor characteristics. In addition, even during the consecutive image formation, the values of a1, a2, b1, and b2 are obtained by measuring and detecting the natural environment such as the temperature or the moisture regularly, or detecting the drive time or the driven mileage of the photoconductive drum for judging fatigue of the photoconductive drum, and then estimating the unexposed surface potential value Vo and the exposed surface potential value VL from these values. Consequently, the charging potential Vd can be obtained from the result (expression 4).

The values of a1, a2, b1, and b2 are shown in Table 1 in FIG. 5 for example to show a detailed example for calculating the charging potential Vd.

### EXAMPLE 1

The temperature near the photoconductive drum 103 is measured for determining the natural environment, and the values of a1, a2, b1, and b2 are determined from the surface potential data stored in the memory 65 on the basis of the measured temperature. Determination of the values of a1, a2, b1, and b2 is obtained by (1) actually measuring the unexposed surface potential value Vo and the exposed surface potential value VL at two points; the charging potential Vd1 and the charging potential Vd2 for each natural environmental temperature in the periphery of the photoconductive drum 103 using a surface potentiometer manufactured by TREK Japan, (2) obtaining a similar graph as shown in FIG. 4 for each natural environmental temperature from the actually measured unexposed surface potential value Vo1 and the exposed surface potential value VL1 at the charging potential Vd1, and the actually measured unexposed surface potential value Vo2 and the exposed surface potential value VL2 at the charging potential Vd2, and (3) determining the values of a1, a2, b1, and b2 shown in Table 1 in FIG. 5 from the obtained graph and storing the same in the memory 65 in the CPU 60. The values of a1, a2, b1, and b2 for each natural environmental temperature shown in FIG. 5 are obtained by actually measuring in a state in which the drive time of the photoconductive drum 103 is zero.

When an adequate values of the developing potential Vc and the background potential Vbg are proved on the basis of the charging characteristics of the photoconductive drum 103, the characteristics of the toner and developer, and the peripheral temperature to be detected by the color printer apparatus 1, the charging potential Vd for obtaining the surface potential required on the photoconductive drum 103 is obtained by the computation of the expression (3) and the expression (4) using the first approximate expression and the second approximate expression including these values and the values of a1, a2, b1, and b2.

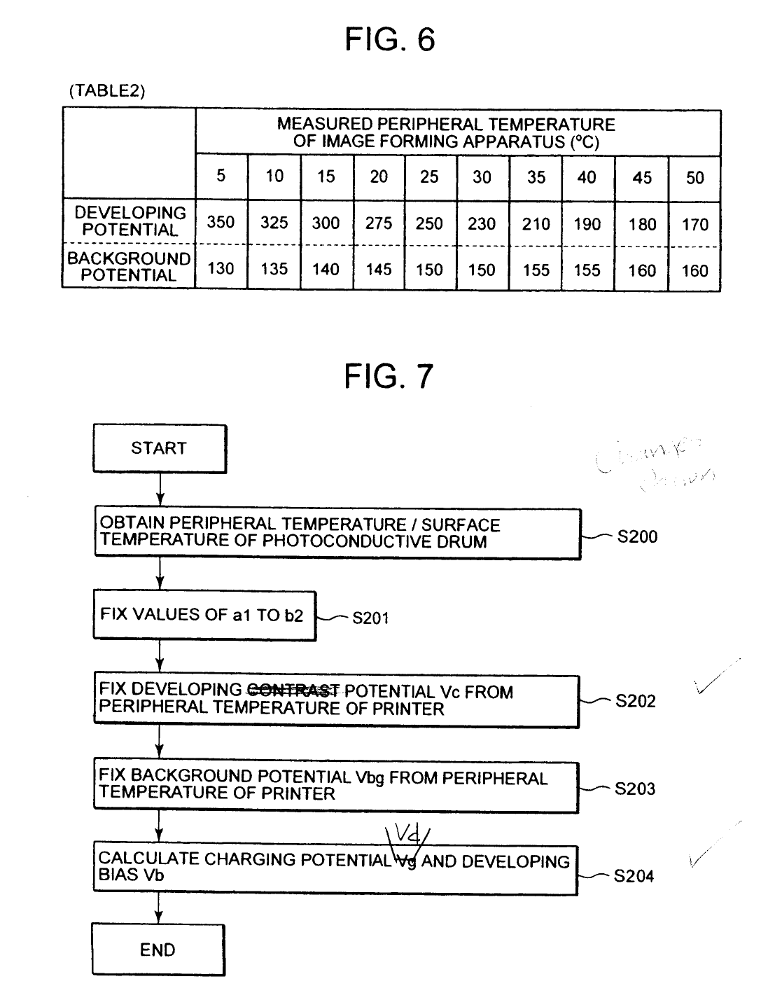

An example of the adequate values of the developing potential Vc and the background potential Vbg on the basis of the peripheral temperature of the photoconductive drum 103 will be shown in Table 2 in FIG. 6. The adequate values of the developing potential Vc and the background potential Vbg shown in Table 2 are stored in the memory 65 in CPU 60. The characteristics of the toner and developer in black (K), cyan (C), magenta (M), and yellow (Y) are different from each other. Therefore, four each of the adequate values of the developing potentials Vc and the background potentials Vbg are prepared for each temperature for each toner color.

For example, when the temperature sensor 31 indicates that the peripheral temperature of the color printer apparatus 1 is 25° C., the fact that the adequate value of the developing potential is Vc=250V, and the adequate value of the background potential is Vbg=150V is proved from Table 2.

Therefore, from

Vc+Vbg=250+150

Vo−VL=(0.953−0.202)×Vd+(−8−19)

Vc+Vbg=Vo−VL

400=0.751×Vd+(−27)

using the first approximate expression and the second approximate expression, ti vd=569(−V) is found.

As is clear from FIG. 4, since Vb=Vo−Vbg,

Vb=Vo−Vbg

=(a1×Vd+b1)−150

=0.953×569−8−150=384(−V) is calculated.

A series of the computation is performed according to a flowchart shown in FIG. 7. A series of the computation starts determination of the temperature of the photoconductive drum 103 and the natural environmental temperature in the periphery of the printer 102 (or the peripheral temperature of the photoconductive drum 103) simultaneously when adjustment of the image forming conditions is started during consecutive image forming process (Step 200). The temperatures in the peripheries of the photoconductive drum 103 and the printer 102 are checked up with Table 1 and Table 2, and the values of a1, a2, b1, and b2 are determined from Table 1 (Step 201). The developing potential Vc and the background potential Vbg are obtained from Table 2 (Step 202, Step 203). The method of calculating the charging potential Vd and the developing bias Vb from these values is as described already (Step 204).

When Table 1 and Table 2 are different in black (K), cyan (C), magenta (M), and yellow (Y), the charging potentials Vd and the developing biases Vb are computed and calculated for each color from the four values prepared for each color in Table 1, Table 2 according to the method shown above.

It is assumed that the peripheral temperature of the printer 102 was not changed, but the surface temperature of the photoconductive drum 103 is increased to 35° C. due to the further environmental change. In this case, the unexposed surface potential value Vo and the exposed surface potential value VL vary. However, in this case as well, the charging potential Vd=531(−V), and the developing bias Vb=339 (−V) can be calculated immediately by computing the following expressions.

Vc+Vbg=250+150 (from 25° C. in Table 2)

Vo−VL=(0.947−0.194)×Vd+(−14−9) (from 35° C. in Table 1)

From 400=0.753×Vd+(−23)

Vd=562(−V) is obtained.

Also,

Vb=Vo−Vbg

=0.947×562+(−14)−150=368(−V) is calculated.

Therefore, even when the characteristics of the unexposed surface potential value Vo and the exposed surface potential value VL are changed according to the change of the environment, or when the adequate values of the developing potential Vc and the background potential Vbg are changed, the charging voltage Vd and the developing bias Vb that enable reproduction of the developing potential Vc and the background potential Vbg on the photoconductive drum are obtained easily only by changing the image forming conditions according to the calculated result.

Consequently, the change in surface potential due to the influence of the natural environment can be accommodated easily by the values of a1, a2, b1, and b2 from the data values stored in the CPU 60 and the temperature of the photoconductive drum and the peripheral temperature sensed by the various sensors provided in the CPU 60.

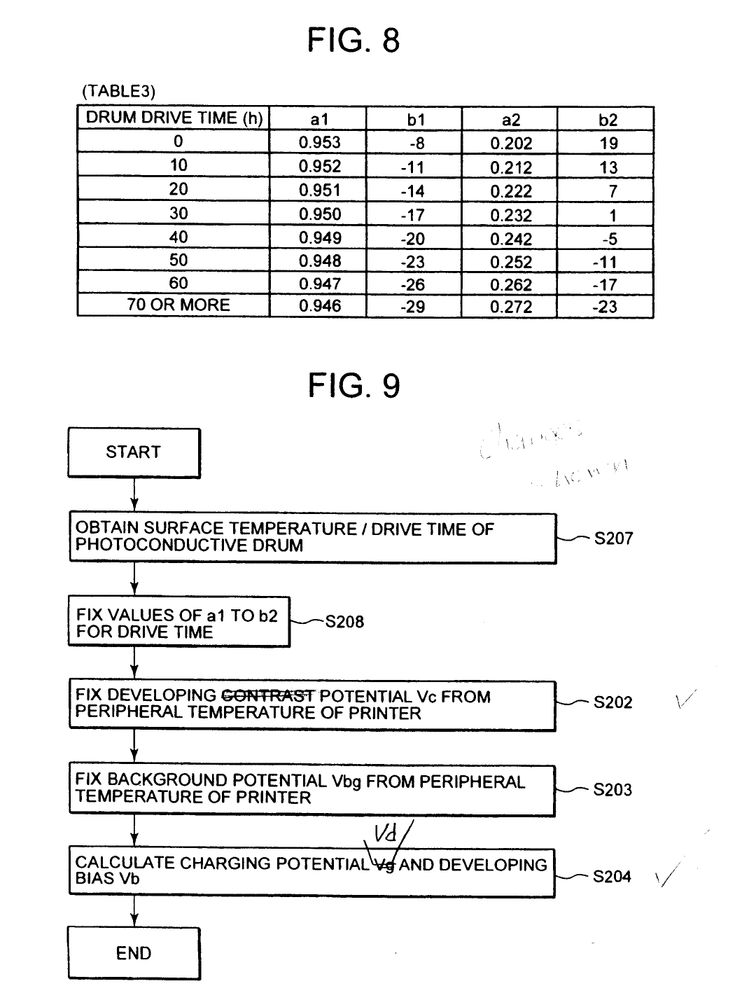

When the unexposed surface potential value Vo and the exposed surface potential value VL are affected by the natural environment and the photoconductive drum 103 is deteriorated, the values of a1, a2, b1, and b2 as shown in Table 3 in FIG. 8 are prepared.

Accordingly, even during the consecutive image formation, the CPU 60 can determine the temperature of the photoconductive drum 103 at real time, determine fatigue form the drive time of the photoconductive drum 103, check off the determined results with Table 3, and obtain the values of a1, a2, b1 and b2. Table 3 shows the result of measurement of the change of the surface potential of the photoconductive drum 103 according to the drive time when the temperature of the photoconductive drum 103 is 25° C. in a1, a2, b1, and b2 in the same manner as Table 1.

For example, the drive time of the photoconductive drum 103 is determined form the drive time counter 35, and is assumed to be 50 hours. Then, the charging potential Vd is obtained by performing computation as follows.

From expressions:

Vc+Vbg=250+150

Vo−VL=(0.948−0.252)×Vd+{(−23)−(−11)},

Vd=592(−V) is obtained.

Also, a expression

Vb=Vb−Vbg

=(a1×Vd+b1)−150

=0.948×592+(−23)−150=388(−V)

is calculated.

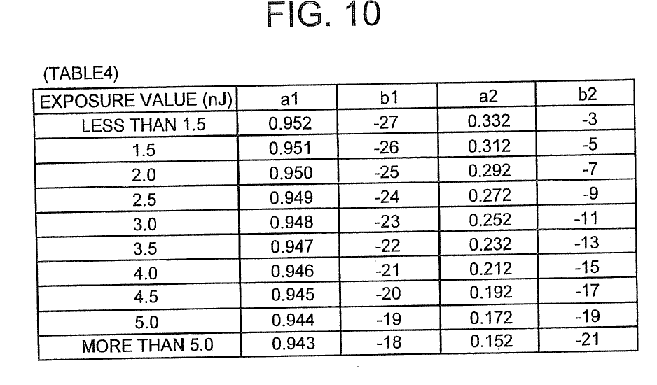

A series of this computation is performed according to a flowchart shown in FIG. 9. A series of this computation determines the surface temperature of the photoconductive drum 103 and the drive time while performing the image forming process consecutively (Step 207). For example, the drive time of the photoconductive drum 103 when the temperature of the photoconductive drum 103 is 25° C. is checked off with Table 2, Table 3, and the values of a1, a2, b1, and b2 are obtained from Table 3 (Step 208). The developing potential Vc and the background potential Vbg are obtained from Table 2 (Step 202, Step 203). From these values, the charging potential Vd and the developing bias Vb are calculated (Step 204).

Subsequently, a case in which the required image quality cannot be obtained only with the developing potential Vc and the background potential Vbg any longer due to the natural environment and the fatigue of the photoconductive drum 103 will be described. In this case, in the printer 102 employing the reverse development, the exposure value L to be applied to the photoconductive drum 103 at the time of image formation may be changed to obtain the required image quality. However, when the exposure value L is changed, the unexposed surface potential value Vo and the exposed surface potential value VL change even when the natural environment and the fatigue of the photoconductive drum 103 are the same.

Therefore, the values of a1, a2, b1, and b2 as shown in Table 4 in FIG. 10 are obtained and stored in the memory 65 from the actually measured surface potential data according to the surface temperature, the drive time, and also the exposure value L of the photoconductive drum 103.

Accordingly, the CPU 60 senses the temperature of the photoconductive drum 103 at real time even during consecutive image formation and determines the drive time of the photoconductive drum 103, and, in addition, the exposure values L are checked up with Table 4 in the state of being changed, so that the values of a1, a2, b1, and b2 are obtained. Table 4 shows the variation of the surface potential of the photoconductive drum 103 according to the exposure value L when the temperature of the photoconductive drum 103 is 25° and the drive time is 50 hours in the values of a1, a2, b1, and b2 in the same manner as Table 1. Assuming that the exposure value L is changed form 3.0 nJ to 4.0 nJ when the surface temperature of the photoconductive drum 103 is 25° C. and the drive time is 50 hours, then, the charging potential Vd can be calculated with the following computation.

From expressions;

Vc+Vbg=250+150

Vo−VL=(0.946−0.212)×Vd+{(−21)−(−15)},

Vd=553(−V) is obtained.

Also, an expression;

Vb=Vo−Vbg

=(a1×Vd+b1)−150

=0.946×553+(−21)−150=352(−V) is calculated.

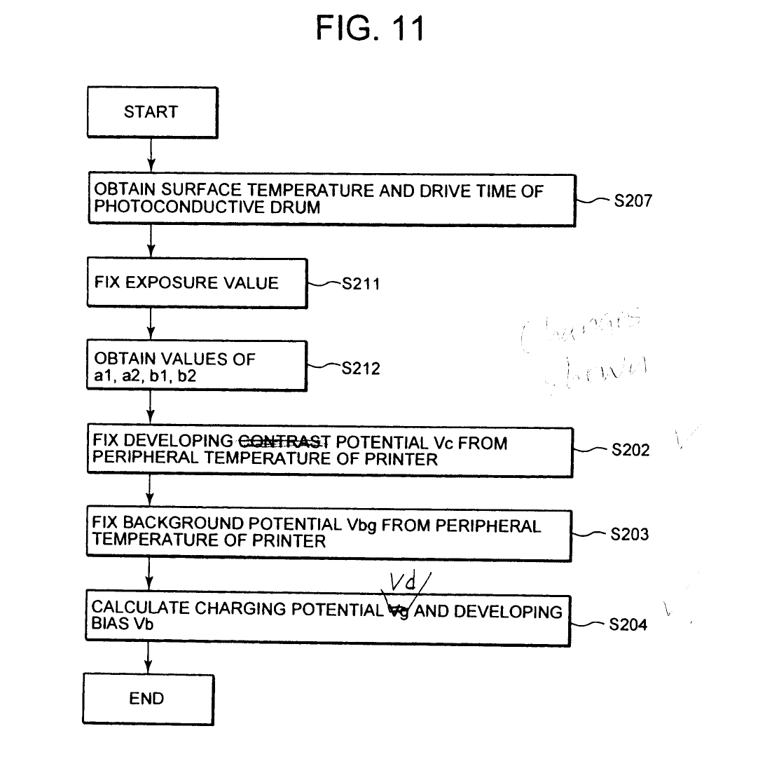

A series of this computation is performed according to a flowchart in FIG. 11. A series of the computation determines the temperature of the photoconductive drum 103 and the drive time counter 35 while performing the image forming process consecutively (Step 207). Then, the varied exposure value L is determined (Step 211). The values of a1, a2, b1, and b2 are obtained from Table 4 by checking up with Table 2 and Table 4 (Step 212). From Table 2, the developing potential Vc and the background potential Vbg are obtained (Step 202, Step 203). From these values, the charging potential Vd and the developing bias Vb are computed (Step 204).

In Example 1, the relation between the charging potential (lateral axis; Vd) and the surface potential of the photoconductive drum 103 (vertical axis; Vo) in the printer 102 employing the reverse development can be expressed in the linear function graph shown in FIG. 4 according to the surface temperature and the drive time of the photoconductive drum 103 and the exposure value L at the time of image formation with examples shown in Table 1 to Table 4. Accordingly, in the color printer apparatus 1, the charging potential Vd and the developing bias Vb for obtaining the surface potential required on the photoconductive drum 103 are obtained using the linear function expression according to the charging characteristic of the photoconductive drum 103, the characteristic of the toner and developer, the adequate values of the developing potential Vc and the background potential Vbg determined on the basis of the peripheral temperature detected by the color printer apparatus 1. Therefore, it is no longer necessary to detect the developing potential Vc and the background potential Vbg on the photoconductive drum 103 by the potential measuring device using the sensors.

The adequate values of the developing potential Vc, the background potential Vbg and the exposure value L may be shown in the table as adequate potentials in the change of the natural environment including the temperature in the periphery of the color printer apparatus 1 as shown in Table 2.

Alternatively, the adequate values of the developing potential Vc, the background potential Vbg, and the exposure value L may be obtained by forming a test pattern on an image carrier member such as the photoconductive drum 103 or the intermediate transfer belt 106a and feeding back the toner density thereof. For example, an unfixed toner image (test pattern) is formed on the intermediate transfer belt 106a and the density of the toner image (the attached amount) is measured using a density sensor (amount of attached toner sensor) such as the pattern density sensor 34. Then, the amount of error with respect to the target density (the attached amount) is obtained from the measured result, and the obtained amount of error is multiplied by a feedback gain, so that optimal developing potential Vc, background potential Vbg and also exposure value L in the control loop are obtained. Then, the developing potential Vc, the background potential Vbg, and also the exposure value L are obtained from the measured result of the toner density of the test pattern, and the values of a1, a2, b1, and b2 corresponding to the measured results of the natural environment are determined, so that the required values of the charging potential Vd and the developing bias Vb are calculated from the developing potential Vc, the background potential Vbg, the exposure value L and the values of a1, a2, b1, and b2 according to the method described already.

Example 1 shown above is a method of obtaining the image forming conditions, for example, at the first processing velocity. On the other hand, when the color printer apparatus 1 has a plurality of processing velocities, it is necessary to obtain the image forming conditions when performing the image formation at processing velocities other than the first processing velocity. The image forming conditions in the case of the processing velocities other than the first processing velocity are also obtained in the same manner as Example 1.

When the color printer apparatus 1 performs the image formation at the processing velocity other than the first processing velocity, the values of a1, a2, b1, and b2 are different from Table 1, Table 3, and Table 4 prepared for the first processing velocity even though the temperature, the fatigue, and the exposure value L of the photoconductive drum 103 are the same. Therefore, parameter tables of the values of a1, a2, b1, and b2 corresponding to Table 1, Table 3, and Table 4 according to the respective temperatures, drive times and exposure values L are prepared for second or third processing velocities other than the first processing velocity.

When switching the processing velocity, the values of a1, a2, b1, and b2 are determined from the prepared parameter table, and then the image forming conditions is calculated using the first approximate expression and the second approximate expression. Accordingly, the charging potential Vd and the developing bias Vb which can reproduce high-accuracy developing potential Vc and the background potential Vbg on the photoconductive drum are obtained.

### EXAMPLE 2

In the above-described Example 1, the adequate values of the developing potential Vc, the background potential Vbg, or the exposure value L are determined from the respective Tables prepared corresponding to the natural environment, the fatigue of the photoconductive drum, or the exposure value L, or the test pattern is determined from the results measured by the pattern density sensor, and then the charging potential Vd and the developing bias Vb required for reproducing the adequate values of the developing potential Vc and the background potential Vbg on the photoconductive drum 103 are calculated.

In Example 2, the adequate values of the developing potential Vc, the background potential Vbg, and the exposure value L at each processing velocity are determined on the basis of the above-described Example 1 when the processing velocity is changed.

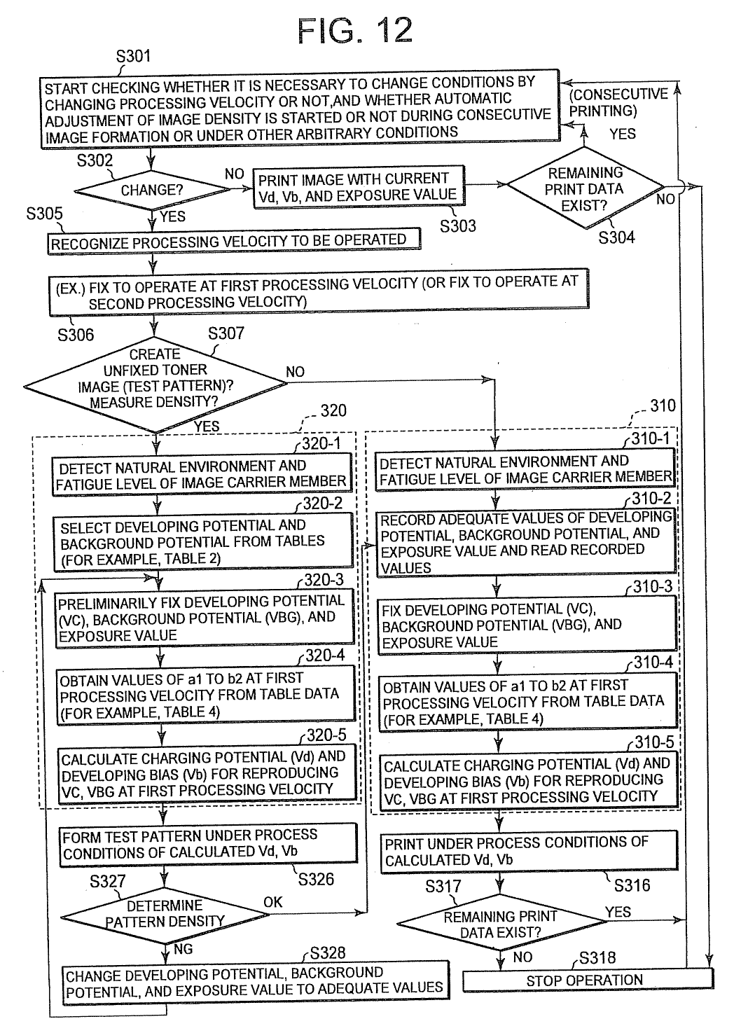

In this example, the color printer apparatus 1 is provided with a plurality of processing velocities. Therefore, the adequate values of the developing potential Vc, background potential Vbg, and exposure value L are determined according to the respective processing velocities. Firstly, determination of the primary image forming conditions of the potential Vc, the background potential Vbg, and the exposure value L in the first processing velocity will be described using a flowchart shown in FIG. 12.

Firstly, determination of whether the change of the processing velocity at the beginning of the image formation or during the consecutive image formation is necessary or not, whether a change for adjusting the image forming conditions after the change of the processing speed is necessary or not, or whether an automatic adjustment of the image density has started or not is started (Step 301). A case in which the processing velocity is switched into a plurality of processing velocities such as a velocity for normal paper or a velocity for thick paper according to the processing velocity at the beginning of the image formation or data during the consecutive image formation (mixed data), or a timing when the color printer apparatus 1 determines whether adjustment of the image density is necessary or not according to the natural environment or a progress of the fatigue of the photoconductive drum 103 are pointed.

When it is determined that the processing velocity has not been changed, or adjustment of the image density is not necessary (when No is selected in Step 302), the operation of the image forming process is performed in a state in which the charging potential Vd, the developing bias Vb and the exposure value L are kept in the current state in Step 303. Whether the memory of the print data remains or not is determined in Step 304 and, if not, it is determined that the entire printing job is completed, and the procedure goes to Step 318, and the operation of the color printer apparatus 1 is stopped. In contrast, when the memory remains in Step 304, whether the change of the processing velocity is necessary or not, and whether adjustment of the image density is necessary or not are determined again in Steps 301 and 302. Since the case in which the change of the processing velocity or adjustment of the image density is necessary means that the change of the image forming conditions (the charging potential Vd, the developing biases Vb, the exposure value L) is necessary, the procedure goes to Step 305.

In Step 305, the processing velocity to be operated is recognized from among the plurality of processing velocities that the color printer apparatus 1 has. When the first processing velocity is determined to be operated in Step 306, the control device 50 controls the drive mechanism 130 to switch the processing velocity of the color printer apparatus 1. The first processing velocity is, for example, the processing velocity applied to the case of color printing on normal paper. The processing velocities other than that are the processing velocities applied to the case of printing using a thick paper having a basic weight larger than the normal paper, or the case of monochrome printing.

Subsequently, when changing the image forming conditions, for example, as Table 2 described already in Example 1, the image forming conditions are changed and determined with reference to the table values prepared in advance (Step 310). Alternatively, the image forming conditions are changed and fixed by forming the toner image (test pattern) on the image carrier member such as the photoconductive drum 103 or the intermediate transfer belt 106a, and recognizing the state of the color printer apparatus 1 by the pattern density sensor 34 (measuring unit) (Step 320). A step used for changing and fixing the image forming conditions is determined from between Step 310 or Step 320 (Step 307). The former (Step 310) is referred to as an open-loop operation, and the latter (Step 320) is referred to as a closed-loop operation.

In the case of the open-loop operation (Step 310), the CPU 60 detects the natural environment, the fatigue of the photoconductive drum 103, the surface temperature of the photoconductive drum 103 and so on from the respective sensors 30 to 34 or the drive time counter 35 (Step 310-1). According to the detected result, a table value which corresponds to Table 2 at the first processing velocity is read from the memory 65 (Step 310-2). Alternatively, the adequate values of the developing potential, the background potential, and the exposure value shown in Step 310-2 may be new records of the primary image forming conditions fixed by the closed-loop operation (Step 320). The developing potential Vc, the background potential Vbg, and the exposure value L are shown and the developing potential Vc, the background potential Vbg, and the exposure value L are determined from the table value prepared in Step 310-2 (Step 310-3). In order to realize the fixed conditions of the developing potential Vc, the background potential Vbg and the exposure value L as the surface potential on the photoconductive drum 103, the first approximate expression and the second approximate expression shown in Example 1 are used.

At this time, the values of a1, a2, b1, and b2 at the first processing velocity are obtained from a parameter table corresponding to Table 4 showing these values according to the respective values of the temperature, the drive time, and the exposure value L at the first processing velocity (Step 310-4). Then, from the fixed values of the developing potential Vc, the background potential Vbg, and the exposure value L and the values of a1, a2, b1, and b2, the charging potential Vd and the developing bias Vb are computed in the same manner as Step 204 in Example 1 (Step 310-5).

Subsequently, the charging potential Vd and the developing bias Vb calculated in Step 310-5 are supplied to the control device 50, and the printing operation is performed (Step 316). Whether the memory of the print data remains or not is determined in Step 317. If there is a memory remained, the procedure goes back to Steps 301 and 302, and the printing job is continued while determining whether the change of the image forming conditions is necessary or not. When there is no memory remained, the entire printing job is determined to be completed, and the procedure goes to Step 318, where the printing operation is stopped.

On the other hand, in the case of the closed-loop operation (Step 320), the CPU 60 detects the natural environment, the fatigue of the photoconductive drum 103, the surface temperature of the photoconductive drum 103 and so on with the respective sensors 30 to 34 or the drive time counter 35 (Step 320-1). According to the detected result, a table value which corresponds to Table 2 at the first processing velocity is read from the memory 65, and the developing potential Vc, the background potential Vbg, and the exposure value L are selected from the read table values (Step 320-2). The developing potential Vc, the background potential Vbg, and the exposure value L selected in Step 320-2 are the primary image forming conditions for forming the test pattern. That is, they are preliminary primary image forming conditions, and are not regarded as adequate values at the first processing velocity (Step 320-3). In Step 320-3, the first approximate expression and the second approximate expression shown in Example 1 are used for reproducing the preliminarily fixed developing potential Vc and the background potential Vbg on the photoconductive drum.

At this time, the values of a1, a2, b1, and b2 at the first processing velocity are obtained from a parameter table corresponding to Table 4 showing these values according to the respective values of the temperature, the drive time, and the exposure value L at the first processing velocity (Step 320-4). Then, from the provisionally fixed values of the developing potential Vc, the background potential Vbg, and the exposure value L and the values of a1, a2, b1, and b2, the charging potential Vd and the developing bias Vb are computed (Step 320-5). Subsequently, the charging potential Vd and the developing bias Vb calculated preliminarily in Step 320-5 are supplied to the control device 50 to form the test pattern (Step 326).

Subsequently, the amount of attached toner (the toner density) of the test pattern is sensed by the pattern density sensor 34, and the density is determined by the pattern density determination unit 64 from the sensed result (Step 327). There is a target value prepared in advance for determination of the density, and when the sensed result of the test pattern is in the vicinity of the target value, it is determined that the desired density is obtained (OK in Step 327). At this time, since the values of the developing potential Vc, the background potential Vbg, and the exposure value L when the test pattern is formed are adequate values, the procedure goes to Step 310-2, where the developing potential Vc, the background potential Vbg, and the exposure value L, which are considered to be adequate are stored in the memory 65.

Then, in the same manner as the open-loop operation, the charging potential Vd and the developing bias Vb for reproducing the developing potential Vc and the background potential Vbg on the photoconductive drum 103 are calculated (Step 310-3 to Step 310-5). Then, the printing operation is performed by the calculated values of the charging potential Vd and the developing bias Vb (Step 316). Whether the memory of the print data remains or not is determined in Step 317. If there is a memory remained, the procedure goes back to Step 301 and 302, and the printing job is continued while determining whether the change of the image forming conditions is necessary or not as needed. When there is no memory remained, the entire printing job is determined to be completed, and the procedure goes to Step 318, where the operation of the color printer apparatus 1 is stopped.

When the sensed result of the test pattern is not in the vicinity of the target value and hence it is determined that the desired density is not obtained (NG in Step 327), the developing potential Vc, the background potential Vbg, and the exposure value L when the test pattern is formed are not adequate. Therefore, it is necessary to correct and adjust the developing potential Vc, the background potential Vbg, and the exposure value L at the time when the test pattern is formed.

That is, the developing potential Vc, the background potential Vbg, and the exposure value L are changed to adequate values (Step 328). The (adequate values of) the developing potential Vc, the background potential Vbg, and the exposure value L obtained by the change in Step 328 are referred to as a new image forming process at the first processing velocity. An example of a method of changing the values of the developing potential Vc, the background potential Vbg, and the exposure value L in Step 328 is a method of obtaining optimal values of the developing potential Vc, the background potential Vbg, and also the exposure value L in the control loop by obtaining the amount of error between the amount of attached toner of the test pattern (the pattern density) and the target value by the pattern density sensor 34, and multiplying this value by the feedback gain. Alternatively, there is also a method of obtaining the same by changing the values of the developing potential Vc, the background potential Vbg, and the exposure value L in sequence by using a binary-search method until the amount of error is lowered to a value lower than a certain value.

Subsequently, the procedure goes back to Step 320-3. In Step 320-3, the values of the developing potential Vc, the background potential Vbg, and the exposure value L changed in Step 328 are preliminarily fixed again as the primary image forming conditions. The charging potential Vd and the developing bias Vb are computed from the preliminarily fixed values of the developing potential Vc, the background potential Vbg, and the exposure value L and the values of a1, a2, b1, and b2 (Step 320-4, 320-5) as the image forming conditions. Then, the test pattern is formed again (Step 326) and the pattern density is determined (Step 327). The processes of Step 320-3 to Step 328 are repeated until the sensed result of the test pattern reaches a value in the vicinity of the target value.

When the sensed result of the test pattern reaches the value in the vicinity of the target value, it is determined to be OK in Step 327, and hence the procedure goes to Step 310-2, where the adequate values of the developing potential Vc, the background potential Vbg, and the exposure value L are recorded in the memory 65 (Step 310-2). Then, the developing potential Vc, the background potential Vbg, and the exposure value L are fixed (Step 310-3), and then the charging potential Vd and the developing bias Vb are calculated (Step 310-4, Step 310-5), and the printing operation is performed until there is no more memory remained.

Determination to measure the density of the unfixed toner image (test pattern) is made in Step 307 only when certain conditions are satisfied. More specifically, the conditions are set arbitrarily such as when the natural environment in the periphery of the color printer apparatus 1 is significantly changed, when adjustment of the image forming conditions has not been performed for more than a certain period, or when a user of the color printer apparatus 1 requests adjustment of the image quality using the test pattern. The adjustment of the image forming conditions by determining the density from Step 320 on is performed only when the preset conditions are met.

Subsequently, the change of the image forming conditions at another processing velocity, for example, at the second processing velocity, as one of the processing velocities which corresponds to the plurality of processing velocities provided in the color printer apparatus 1 other than the first processing velocity will be described. The change of the image forming conditions at the second processing velocity may be performed in the open-loop operation (Step 310) and the closed-loop operation (Step 320) as in the case of the change of the image forming conditions at the first processing velocity.

Therefore, the change of the image forming conditions at the second processing velocity will be described using the flowchart shown in FIG. 12 which was used for fixing the image forming conditions at the first processing velocity. However, the recognition and the fixation of the processing velocity in Steps 305 and 306 are replaced by the second processing velocity. In Step 310-2, Step 310-4, Step 320-2, and Step 320-4, a table prepared for the second processing velocity is used. In determination of the density in Step 327, a target value for the second processing velocity is prepared.

The fixation of the image forming conditions at the second processing velocity is started by determination of whether the change of the processing velocity is necessary or not, whether the change for adjusting the image forming conditions is necessary or not during the consecutive image formation or under the arbitrary conditions (Step 301). When it is determined that the change of the processing velocity or the change of the image forming conditions is necessary in Step 302, which processing velocity is desired from among the plurality of processing velocities that the color printer apparatus 1 has is recognized in Step 305. When the second processing velocity is selected for operation in Step 306, the drive mechanism 130 is controlled by the control device 50 to switch the processing velocity. Then, in the same manner as the method of obtaining the image forming conditions at the first processing velocity described above, either the open-loop operation (Step 310) or the closed-loop operation (Step 320) from Step 307 on in FIG. 12 is performed. Furthermore, the charging potential Vd and the developing bias Vb are calculated from the fixed values of the developing potential Vc, the background potential Vbg, and the exposure value L and the values of a1, a2, b1, and b2 at the second processing velocity to achieve the adequate image formation.

The second processing velocity represents a processing velocity applied to the case of printing a thick paper having a basic weight larger than the normal paper, or the case of monochrome printing in comparison with the first processing velocity applied to the case of color printing on normal paper.

According to Example 2, even when the processing velocity is changed in the color printer apparatus 1 having the plurality of processing velocities, the adequate values of the developing potential Vc, the background potential Vbg, and the exposure value L can be determined from the parameter tables corresponding to the respective arbitrary processing velocities as in the same manner as the above-described Example 1. Furthermore, the charging potential Vd and the developing bias Vb for reproducing the required developing potential Vc and the background potential Vbg on the photoconductive drum 103 are calculated easily. Accordingly, it is no longer necessary to detect the surface potential by the potential measuring device using the sensors in order to obtain the developing potential Vc and the background potential Vbg on the photoconductive drum 103.

### EXAMPLE 3

When the color printer apparatus 1 having the plurality of processing velocities is configured in such a manner that any one of the open-loop operation and the closed-loop operation may be selected when changing and fixing the image forming conditions according to the respective processing velocities as in the case of the above-described Example 2, if the type of switchable processing velocities increases, there arise adverse effects such that the number of times of switching of the operation increases and the time required for the control operation in association therewith increases. It is remarkable when executing the closed-loop operation. Also, complication of the control program cannot be avoided.

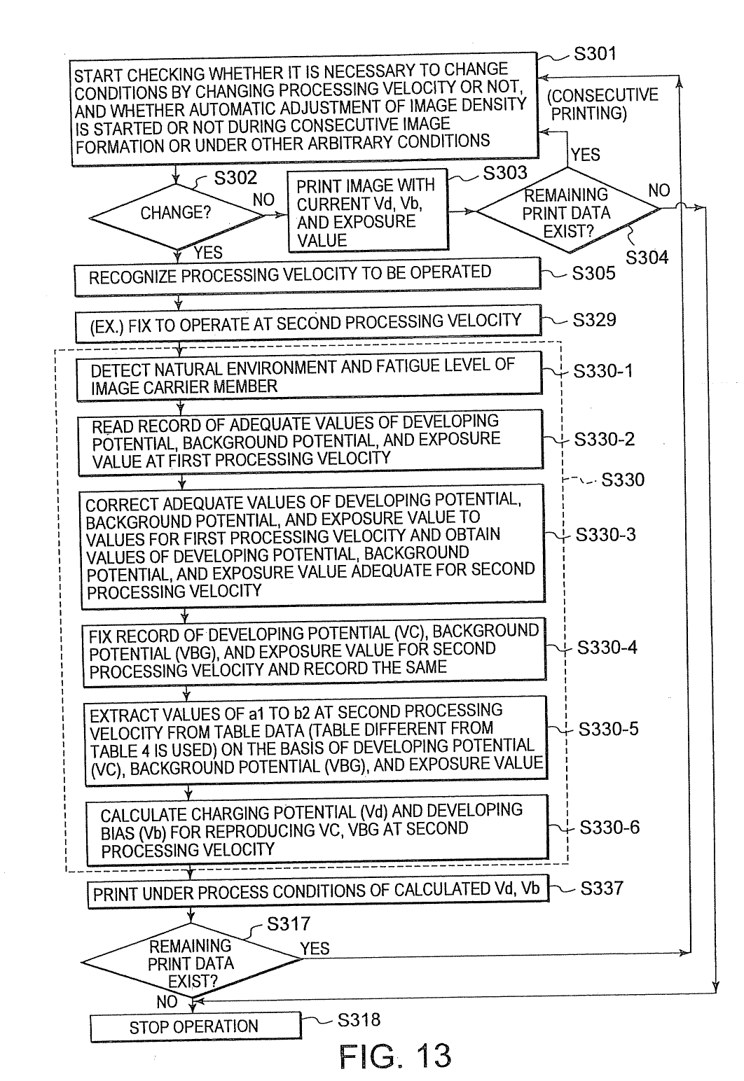

Therefore, in Example 3, on the basis of the first image forming conditions adjusted at a predetermined processing velocity, the first image forming conditions are corrected, changed, and fixed at the processing velocities other than the predetermined processing velocity. Example 3 will be described using a flowchart shown in FIG. 13. During the consecutive image formation or under arbitrary conditions, determination of whether it is necessary to change the processing velocity or not, and whether the change for adjusting the image forming conditions is necessary or not is started (Step 301). When it is determined that the change of the processing velocity or the change of the image forming conditions is necessary, which processing velocity is to be employed from among the plurality of processing velocities that the color printer apparatus 1 has is recognized in Step 305. When the second processing velocity is selected to be operated in Step 329, the control device 50 controls the drive mechanism 130 to switch the processing velocity. The second processing velocity represents a processing velocity applied to the case of printing a thick paper having a basic weight larger than the normal paper, or the case of monochrome printing in comparison with the first processing velocity applied to the case of color printing on normal paper.

Subsequently, when determining the image forming conditions at the second processing velocity, the record of the developing potential Vc, the background potential Vbg, and the exposure value L at the first processing velocity adjusted in Example 2 is used as a reference and corrected, changed and fixed for the image forming conditions at the second processing velocity (Step 330). Firstly in Step 330-1, the natural environment, the fatigue of the photoconductive drum 103, the surface temperature of the photoconductive drum 103 and so on are detected from the respective sensors 30 to 34 and the drive time counter 35. Subsequently, the record of the developing potential Vc, the background potential Vbg, and the exposure value L at the first processing velocity optimized in Example 2 to be stored in the memory 65 is read (Step 330-2).

The read developing potential Vc, background potential Vbg, and exposure value L are not optimal conditions for applying to the second processing velocity. Therefore, the relative relation among the optimal values of the developing potential Vc, the background potential Vbg, and the exposure value L at the first processing velocity and the second processing velocity is extracted. The developing potential Vc, the background potential Vbg, and the exposure value L, which are fixed at the first processing velocity, are corrected and controlled using the extracted certain relative relation between the first processing velocity and the second processing velocity. Accordingly, the developing potential Vc, the background potential Vbg, and the exposure value L suitable for the second processing velocity are obtained (Step 330-3).

The developing potential Vc, the background potential Vbg, and the exposure value L obtained in Step 330-3 are fixed as optimal values at the second processing velocity, and stored in the memory 65 (Step 330-4). The first approximate expression and the second approximate expression shown in Example 1 are used for reproducing the obtained developing potential Vc and background potential Vbg as the surface potentials on the photoconductive drum 103.

At this time, the values of a1, a2, b1, and b2 at the second processing velocity are extracted from the parameter table which corresponds to Table 4 according to the temperature, the drive time, and the exposure value L at the second processing velocity (Step 330-5). Then, the charging potential Vd and the developing bias Vb for reproducing the developing potential Vc and the background potential Vbg at the second processing velocity are calculated from the fixed values of the developing potential Vc, the background potential Vbg, and the exposure value L and the values of a1, a2, b1, and b2 (Step 330-6).

Subsequently, the printing operation is performed by the charging potential Vd and the developing bias Vb calculated in Step 330-6 (Step 337). Subsequently, in Step 317, whether the memory of the print data remains or not is determined. When the memory remains, the procedure goes back to Steps 301 and 302, and the printing operation continues while determining as needed whether it is necessary to change the processing velocity and to change the image forming conditions. When there is no memory remained, it is determined that the entire printing job is completed, and the procedure goes to Step 318, and the operation of the color printer apparatus 1 is stopped.

Subsequently, the relative relation among the optimal values of the developing potential Vc, the background potential Vbg, and the exposure value L at the first processing velocity and the second processing velocity and the content of the correction control will be described in detail.

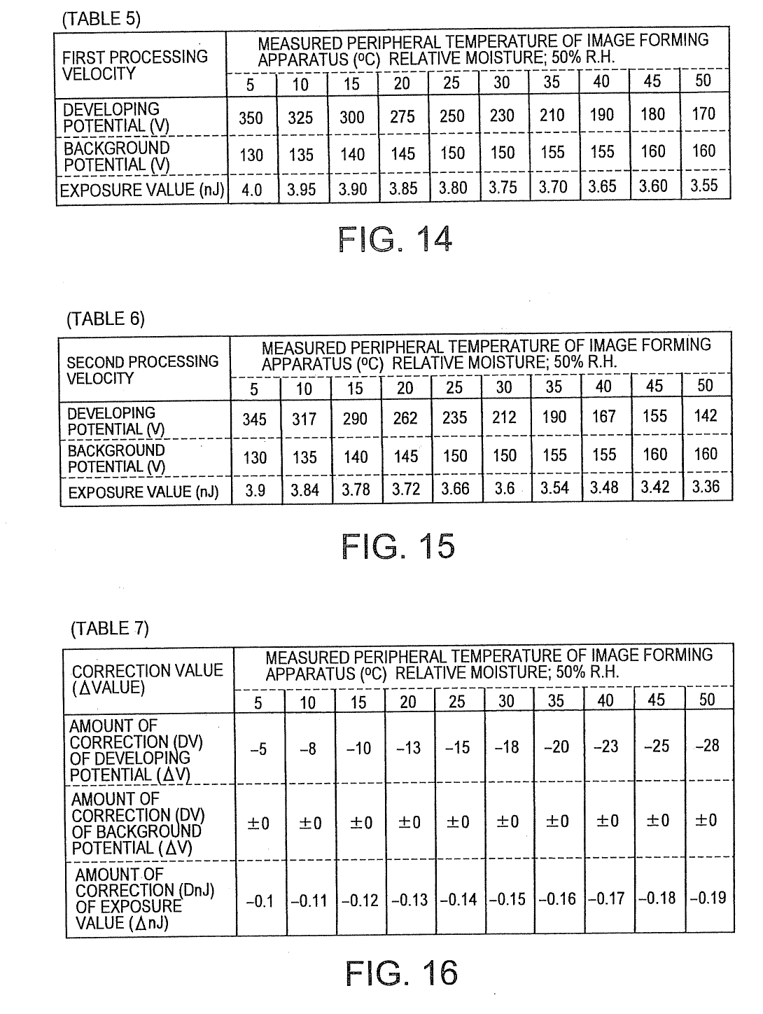

When the closed-loop operation is performed at the first processing velocity and the optimal values of the developing potential Vc, the background potential Vbg, and the exposure value L are obtained using the test pattern in Example 2, Table 5 shown in FIG. 14 is obtained for the respective peripheral temperatures of the color printer apparatus 1.

On the other hand, when the second processing velocity is set to a velocity lower than the first processing velocity, the developing time is longer and the developing efficiency is higher at the second processing velocity. Therefore, at the second processing velocity, even with the lower values than the optimal values of the developing potential Vc, the background potential Vbg, and the exposure value L at the first processing velocity, the same amount of attached toner as the amount of attached toner obtained at the first processing velocity is achieved. Consequently, when the optimal values of the developing potential Vc, the background potential Vbg, and the exposure value L at the second processing velocity are lowered in comparison with the first processing velocity, it is estimated that the desired adequate image is obtained.

When the developing potential Vc, the background potential Vbg, and the exposure value L for obtaining the adequate image at the second processing velocity were actually obtained, Table 6 shown in FIG. 15 was obtained. In Table 6, the values of the developing potential Vc and the exposure value L are lowered in comparison with the values at the first processing velocity shown in Table 5.

From this relationship, by finding the correlation between the optimal values of the developing potential Vc, the background potential Vbg, and the exposure value L at the first processing velocity and the optimal values of the developing potential Vc, the background potential Vbg, and the exposure value L at the second processing velocity (the difference between the optimal value at the first processing velocity and the optimal value at the second processing velocity), a table of the amount of correction in Table 7 as shown in FIG. 16 is prepared.

Therefore, the optimal values of the developing potential Vc, the background potential Vbg, and the exposure value L at the second processing velocity are obtained by adding the amounts of correction shown in Table 7 to the optimal values of the developing potential Vc, the background potential Vbg, and the exposure value L at the first processing velocity shown in Table 5.

That is;

The optimal developing potential Vc at the second processing velocity=the optimal developing potential Vc at the first processing velocity+the amount of correction in Table 7 according to the peripheral temperature

The optimal background potential Vbg at the second processing velocity=the optimal background potential Vbg at the second processing velocity+the amount of correction in Table 7 according to the peripheral temperature

The optimal exposure value L at the second processing velocity=the optimal exposure value L at the second processing velocity+the amount of correction in Table 7 according to the peripheral temperature.

In Example 3, the amounts of correction on the basis of the temperatures detected by the temperature sensor 31 in the color printer apparatus 1 is listed in Table 7. However, it is also possible to list the amounts of correction which correspond to the values in Table 7 with reference to the relative moisture from the table which corresponds to Table 5 and Table 6 on the basis of the detected result of the relative moisture sensor 33 in the color printer apparatus 1, and prepare a table for obtaining the amounts of correction considering both the temperature and the relative moisture.

In this manner, the optimal values of the developing potential Vc2, the background potential Vbg2, and the exposure value L2 at the second processing velocity are fixed with reference to the optimal values of the developing potential Vc1, the background potential Vbg1, and the exposure value L1 at the first processing velocity. The charging potential Vd2 and the developing bias Vb2 at the second velocity for reproducing the optimal values of the developing potential Vc2 and the background potential Vbg2 as the surface potential on the photoconductive drum 103 are calculated.

According to Example 3, even though the first processing velocity is switched as needed to the second processing velocity in the color printer apparatus 1, the adequate values of the developing potential Vc and the background potential Vbg at the second processing velocity are obtained without using a complex control program, and without taking time for the switching control, and the charging potential Vd and the developing bias Vb for reproducing the same on the photoconductive drum 103 can be calculated easily. Accordingly, since the developing potential Vc and the background potential Vbg on the photoconductive drum 103 are obtained every time when the processing velocity is switched, it is no longer necessary to detect the surface potential with the potential measuring device using the sensors.

The invention is not limited to the above-described embodiments, and various modifications may be made without departing the scope of the invention. For example, since the structure of the image forming apparatus is arbitrary, a monochrome image forming apparatus having at least two or more processing velocities may also be applicable. Alternatively, a color image forming apparatus in which the processing velocity is changed only when monochrome image formation is performed may be arbitrarily applied. In the above-described embodiments, the color printer apparatus of a tandem structure in which a plurality of image forming stations are provided and the image formation is achieved with one pass is employed. However, a color image forming apparatus having a revolver structure in which the image forming process is repeated on a single image carrier member by each color is also applicable.

1. An image forming apparatus comprising:
an image carrier member;
an image forming unit including a charging unit configured to charge the surface of the image carrier member evenly and control the amount of electric charge by a charging potential to be applied, an exposure unit configured to form a latent image on the image carrier member, and a developing unit configured to apply a developing bias, supply toner to the latent image on the image carrier member, and develop the same, the image forming unit performing an image forming process on the image carrier member for forming a toner image;
a velocity switching unit that switches the processing velocity in the image forming unit in a plurality of levels;
an estimating unit configured to estimate the unexposed surface potential value of the image carrier member using a first approximate expression as a continuous function of the charging potential of the charging unit and estimate the exposed surface potential value of the image carrier member using a second approximate expression as a continuous function of the charging potential of the charging unit for each processing velocity in a plurality of the processing velocities in the image forming unit;
a first computing unit configured to select one of more of the peripheral environment in the vicinity of the image carrier member, the fatigue, and the exposure value of the exposure unit and define the first and second approximate expressions for estimating the surface potential value of the image carrier member as the continuous function;
a second computing unit configured to compute the charging potential to be applied to the image carrier member and the developing bias of the developing unit using the first and second approximate expressions in order to realize the developing potential and the background potential required for the image forming process on the image carrier member; and
a control unit configured to control the image forming unit for the respective processing velocities switched by the velocity switching means using the computed result of the second computing unit.

2. The image forming apparatus according to claim 1, wherein when defining the first or the second approximate expression for estimating the potential value of the image carrier member as the continuous function, the first or the second approximate expression is estimated using at least one of the temperature, the relative moisture and the absolute moisture in the vicinity of the image carrier member as the peripheral environment in the vicinity of the image carrier member.

3. The image forming apparatus according to claim 1, wherein when defining the first or the second approximate expression for estimating the potential value of the image carrier member as the continuous function, the first or the second approximate expression is estimated using the drive time or the driven distance of the image carrier member as the fatigue of the image carrier member.

4. The image forming apparatus according to claim 1, wherein at least two processing velocities are provided, the definition of the continuous function as a first or the second approximate expression at the first processing velocity is different from the definition of the continuous function as the first or the second approximate expression at the plurality of processing velocities that the image forming process has other than the first processing velocity, and the definition is reattempted and recorded according to the execution of the switching to the processing velocity by the speed switching means.

5. The image forming apparatus according to claim 4, wherein the image forming unit performs the image forming process, form a test pattern as the toner image, and further includes a measuring unit configured to measure the density of the test pattern as the amount of attached toner, and a pattern density determination unit configured to compare the measured value of the amount of attached toner with a preset target value, and determine whether the density of the test pattern is acceptable or not, and
wherein the control unit, when it is determined to be unacceptable, calculates the developing potentials, the background potentials, and the exposure values optimal for the plurality of processing velocities that the image forming process has by creating new process conditions for the image forming process by means for changing any one of the developing potential, the background potential and a exposure value of the image forming process or the plurality of conditions for optimizing the pattern density.

6. The image forming apparatus according to claim 4 wherein the image forming unit performs the image forming process at the first processing velocity, form the test pattern as the toner image, and further includes a measuring unit configured to measure the density of the test pattern as the amount of attached toner, and a pattern density determination unit configured to compare the measured value of the amount of attached toner with a preset target value and determine whether the density of the test pattern is acceptable or not, and
wherein the control unit, when it is determined to be unacceptable, calculates the optimal values of the developing potential, the background potential, and the exposure value as new process conditions for the first processing velocity by means for changing any one of the developing potential, the background potential, and the exposure value of the image forming process, or the plurality of conditions in order to optimize the pattern density, and when the processing velocity is changed to a processing velocity other than the first processing velocity, employs the values obtained by correcting the optimized values of the developing potential, the background potential, and the exposure values at the first processing velocity as the developing potential, the background potential, and the exposure value at the processing velocities other than the first processing velocity.

7. An image forming apparatus comprising:
an image carrier member;
an image forming unit including a charging unit configured to charge the surface of the image carrier member evenly and control the amount of electric charge by a charging potential to be applied, an exposure unit configured to form a latent image on the image carrier member, and a developing unit configured to apply a developing bias, supply toner to the latent image on the image carrier member, and develop the same, the image forming unit performing an image forming process on the image carrier member for forming a toner image;
an estimating unit configured to estimate the unexposed surface potential value of the image carrier member as a continuous function of the charging potential of the charging unit by the first approximate expression and estimate the exposed surface potential value of the image carrier member as a continuous function of the charging potential of the charging unit by the second approximate expression in the image forming unit;
a first computing unit configured to select any one or more of the peripheral environment in the vicinity of the image carrier member, the fatigue, and the exposure value at the time of forming the latent image to define the first and second approximate expressions for estimating the amount of the surface potential of the image carrier member as a continuous function
a second calculating unit configured to compute the charging potential to be applied to the image carrier member and the developing bias of the developing unit for realizing the developing potential and the background potential required for the image forming process on the image carrier member using the first and second approximate expressions; and a control unit configured to control the image forming unit using the computed result of the second computing unit.

8. The image forming apparatus according to claim 7, wherein when defining the first or the second approximate expression for estimating the potential value of the image carrier member as the continuous function, the first or the second approximate expression is estimated using at least one of the temperature, the relative moisture, and the absolute moisture in the vicinity of the image carrier member as the peripheral environment in the vicinity of the image carrier member.

9. The image forming apparatus according to claim 7, wherein when defining the first or the second approximate expression for estimating the potential value of the image carrier member as the continuous function, the first or the second approximate expression is estimated using the drive time or the driven distance of the image carrier member as the fatigue of the image carrier member.

10. The image forming apparatus according to claim 7, wherein at least two processing velocities are provided, the definition of the continuous function as the first or the second approximate expression at a first processing velocity is different from the definition of the continuous function as the first or the second approximate expression at a plurality of processing velocities that the image forming process has other than the first processing velocity and the definition is reattempted and recorded according to the execution of the switching of the processing velocity by the speed switching means.

11. The image forming apparatus according to claim 10, wherein the image forming unit performs the image forming process, form a test pattern as the toner image, and further includes a measuring unit configured to measure the density of the test pattern as the amount of attached toner, and a pattern density determination unit configured to compare the measured value of the amount of attached toner with a preset target value, and determine whether the density of the test pattern is acceptable or not, and
wherein there is provided the control unit, when it is determined to be unacceptable, configured to calculate the developing potentials and the background potentials optimal for the plurality of processing velocities that the image forming process has by creating new process conditions by means for changing the developing potential and the background potential of the image forming process for optimizing the pattern density.

12. The image forming apparatus according to claim 10, wherein the image forming unit performs the image forming process at the first processing velocity, form the test pattern as the toner image, and further includes a measuring unit configured to measure the density of the test pattern as the amount of attached toner, and a pattern density determination unit configured to compare the measured value of the amount of attached toner with a preset target value and determine whether the density of the test pattern is acceptable or not, and
wherein there is provided the control unit configured to create new process conditions for the first processing velocity by means for changing the developing potential and the background potential of the image forming process for optimizing the pattern density, when it is determined to be unacceptable, and employ the values obtained by correcting the optimized values of the developing potential and the background potential at the first processing velocity as the developing potential and the background potential at the processing velocities other than the first processing velocity at the processing velocities other than the first processing velocity.

13. An image forming method for forming a toner image on an image carrier member by performing an image forming process having a charging process for applying the charging potential to the image carrier member at a processing velocity switchable to a plurality of levels, an exposing process for forming a latent image on the image carrier member, and an developing process for applying a developing bias and supplying toner to the latent image on the image carrier member comprising:
estimating the unexposed surface potential value of the image carrier member as a continuous function of the charging potential of the charging unit by a first approximate expression and estimating the exposed surface potential value of the image carrier member as a continuous function of the charging potential of the charging unit by a second approximate expression for the respective processing velocities of the plurality of levels;
defining the continuous function by selecting any one or more of the peripheral environment in the vicinity of the image carrier member, the fatigue, and the exposure value of the exposure unit;
computing the charging potential to be applied to the image carrier member and the developing bias of the developing unit for realizing the developing potential and the background potential required for the image forming process on the image carrier member using the first and second approximate expressions; and performing the charging process on the image carrier member at the computed charging potential for the respective processing velocities of the plurality of levels, and performing the developing process for supplying toner to the latent image on the image carrier member by applying the computed developing bias.

14. The image forming method according to claim 13, wherein when defining the continuous function by selecting any one or more of the peripheral environment in the vicinity of the image carrier member, the fatigue, and the exposure value of the exposure unit, at least one of the temperature, the relative moisture, and the absolute moisture in the vicinity of the image carrier member is selected as the peripheral environment in the vicinity of the image carrier member.

15. The image forming method according to claim 13, wherein when defining the continuous function by selecting any one or more of the peripheral environment in the vicinity of the image carrier member, the fatigue, and the exposure value of the exposure unit, any one of the drive time or the driven distance of the image carrier member is selected as the fatigue of the image carrier member.

16. The image forming method according to claim 13, wherein the image forming process has two or more processing velocities including a first processing velocity and a processing velocity other than the first processing velocity, and
wherein the continuous function defined by selecting any one or more of the peripheral environment in the vicinity of the image carrier member, the fatigue, and the exposure value of the exposure unit is redefined and recorded according to the execution of switching of the processing velocity.

17. The image forming method according to claim 16, further comprising:
forming a test pattern as the toner image;
measuring the density of the test pattern;
comparing the measured density of the test pattern with a preset target value;
when it is determined to be unacceptable as a result of the comparison, changing the developing potential and the background potential of the image forming process for optimizing the pattern density; and
performing the image forming process by feeding back the changed values of the developing potential and the background potential.

18. The image forming method according to claim 16, further comprising:
forming the test pattern as the toner image at the first processing velocity;
measuring the density of the test pattern;
comparing the measured density of the test pattern with a preset target value,
when it is determined to be unacceptable as a result of comparison, changing the developing potential, the background potential, and the exposure value of the image forming process for optimizing the pattern density and feeding back the changed values of the developing potential, the background potential, and the exposure value to perform the image forming process and, when it is determined to be acceptable as a result of comparison, determining the changed values of the developing potential, the background potential, and the exposure value as new values of the developing potential, the background potential, and the exposure value at the first processing velocity; and
at the processing velocities other than the first processing velocity, correcting the new values of the developing potential, the background potential, and the exposure value at the first processing velocity to obtain the developing potential, the background potential, and the exposure value at the processing velocities other than the first processing velocity.
